(19) United States
(12) Patent Application Publication
(10) Pub. No.: US 2003/0164378 A1
(43) Pub. Date: Sep. 4, 2003

(54) Beverage container unloading and dispensing apparatus

(76) Inventor: Anton K. Simson, Escondido, CA (US)

Correspondence Address: CHARMASSON & BUCHACA, 1545 HOTEL CIRCLE SOUTH, SUITE 150, SAN DIEGO, CA, 92108-3412, US

(21) Appl. No.: 10/356,297

(22) Filed: Jan. 30, 2003

Related U.S. Application Data
(60) Provisional application No. 60/353,115, filed on Feb. 1, 2002.

(51) Int. Cl. G07F 11/12

(52) U.S. Cl. 221/11

(57) ABSTRACT

An apparatus for unloading a carton or other package holding a set of cylindrical containers such as beverage cans or bottles, and for dispensing them, one-by-one in a horizontal rolling position into a vessel such as a vending machine magazine.

### PRIOR APPLICATION

This is a continuation of provisional application Serial No. 60/353,115 filed Feb. 1, 2002.

### FIELD OF THE INVENTION

This invention relates to equipment for automatically handling containers, and more specifically for unloading cylindrical containers from their cardboard boxes of flats and dispensing them one-by-one in a rolling, horizontal position into another apparatus.

### BACKGROUND OF THE INVENTION

It is often necessary to load cylindrical containers such as beverage bottles or cans in a rolling and axially horizontal position either into a vending machine or into a magazine designed to be installed in such a machine.

Beverage containers are usually available in flats or cartons wherein several rows of containers are closely held together either by the a shrunk sheet of synthethic material or by the walls of the cartons. In a large operation, wherein thousands of beverage containers must be removed from their original cartons then fed one-by-one into another apparatus, the process can be time consuming, cumbersome and labor-extensive. Such circumstances occur when the beverage containers must be loaded into vending machine's replaceable magazines such as the one used in connection with a new generation of vending machines as illustrated under reference 3 in U.S. Pat. No. 6,478,187 Simson et al. which patent is incorporated herein by this reference.

In an automated vending operation where substitutable and refillable magazines are processed at a central warehouse, it is often necessary to refill magazines from multiple sources. For instance, beverage cans remaining in a partially expended magazine are used to fill another one along with new cans taken from a carton or flat. There is a need for an apparatus that would automate this type of operation.

### SUMMARY OF THE INVENTION

The principal and secondary objects of this invention are to provide a convenient apparatus for unloading a set of cylindrical containers from their packing carton or flat, then dispense them one-by-one in a rolling, axially horizontal position into a vending machine magazine or other vessel.

These and other valuable objects are achieved by an apparatus comprising a liftable and rotatable tray, preferably positioned on a frame at the end of a conveyor in order to receive cartons or flats holding rows of containers.

A transfer box commensurate with the set of containers is rotatably connected along one of its edges to the frame. The transfer box has an open bottom and contains an array of holding fingers shaped, sized and positioned to plunge around and between a layer of containers when they are pushed by the liftable tray through the open bottom of the transfer box.

The transfer box and the tray are then rotated together 90° in order to place the containers into an axially horizontal position with the transfer box slightly tilted toward a dispensing opening located at the lowermost corner of the transfer box.

The tray and cartons are then rotated away from the transfer box and back to the horizontal position at the end of the conveyor.

At that point, the grasping action applied by the holding fingers is sequentially released one row at a time in order to allow the containers to drop into a channel at the base of the transfer box, and roll along it toward the opening. The release of the containers occurs, first, in the highest row furtherest from the dispensing opening.

A gate across the opening interrupts the sequential dispensing of the containers when the receiving vessel or apparatus is full. A microswitch near the gate is used to generate a count of the dispensed containers.

### BRIEF DESCRIPTION OF THE DRAWING

FIG. 1 is a perspective view of the tray and transfer box assembly;

FIG. 2 is a side cross-sectional view of the transfer box;

FIG. 3 is a frontal cross-sectional view thereof; and

FIG. 4 is a side elevational view of the apparatus in its dispensing position.

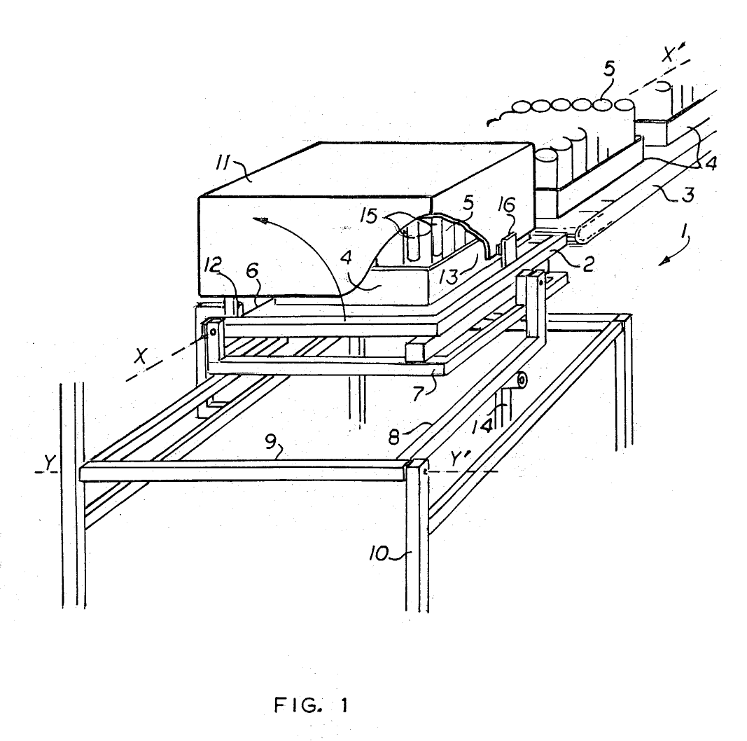

### DESCRIPTION OF THE PREFERRED EMBODIMENT OF THE INVENTION

Referring now to the drawing, there is shown a loader dispenser 1 comprising a liftable and rotatable tray 2 positoned at the end of the conveyer 3. Open cartons or flats 4 of cylindrical containers such as soda cans 5 are moved on the conveyor and deposited one-by-one on the tray 2. The tray is hinged along an inner lateral edge 6 to a cradle 7. The cradle is swingingly suspended to a liftable frame 8. The frame is hinged along a forward transversal edge 9 to a supporting table 10. Accordingly, the tray can be rotated about a longitudinal axis XX′, and along with its supporting cradle 7 and frame 8 can be rotatively lifted about a transversal axis YY′.

A transfer box 11 shaped and dimensioned to accept a flat 4 of cans is hinged to the table 10 along an inner lateral edge 12 about substantially the same axis XX′ as the tray 2. The transfer box has an open bottom 13 and is first positioned slightly above the flat of cans.

A manually operated lever or hydraulically powered push rod 14 is applied to the frame 8 to lift it along with the cradle 7 and tray 2 toward the transfer box. The entire layer of cans penetrates the box where the cans nest between an array of or fingers 15. The fingers are shaped, positioned and dimensioned to releasably grasp the cans and hold them in the same row and column arrangements they were packaged in the flat. As the periphery of the transfer box is contacted by the edge of the tray, a latch 16 locks the tray to the box. The loaded transfer box 11 and tray 2 are then rotated to a vertical dispensing position whereby the box is slightly tilted forwardly downward. The latch on the tray is automatically released and the tray and carton are returned to its horizontal loading position at the end of the conveyor.

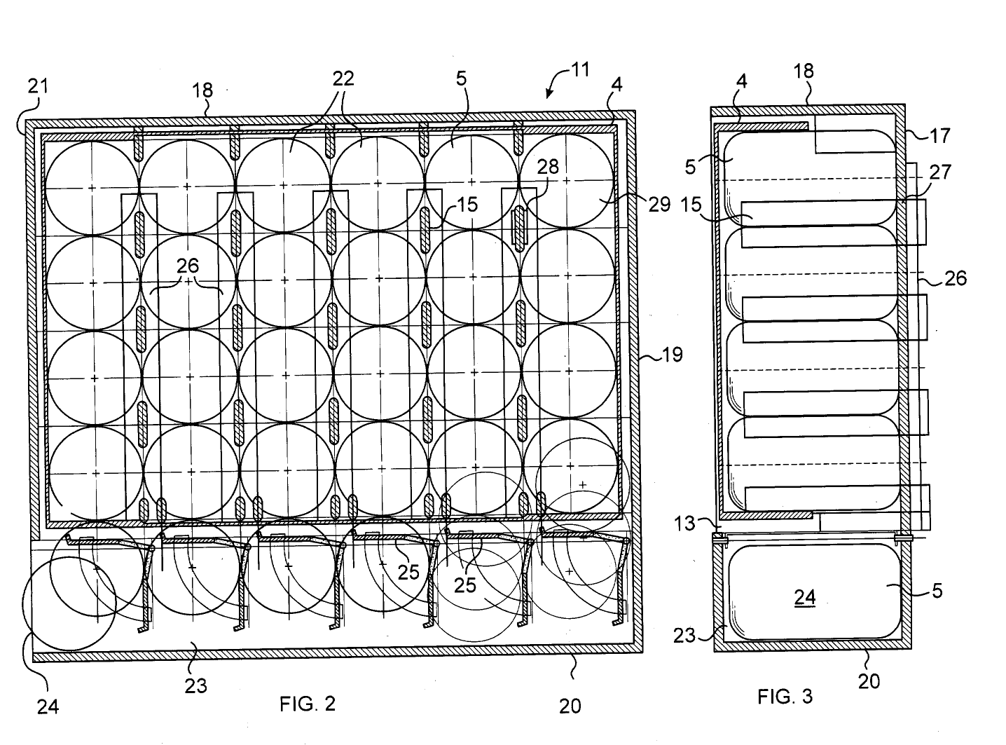

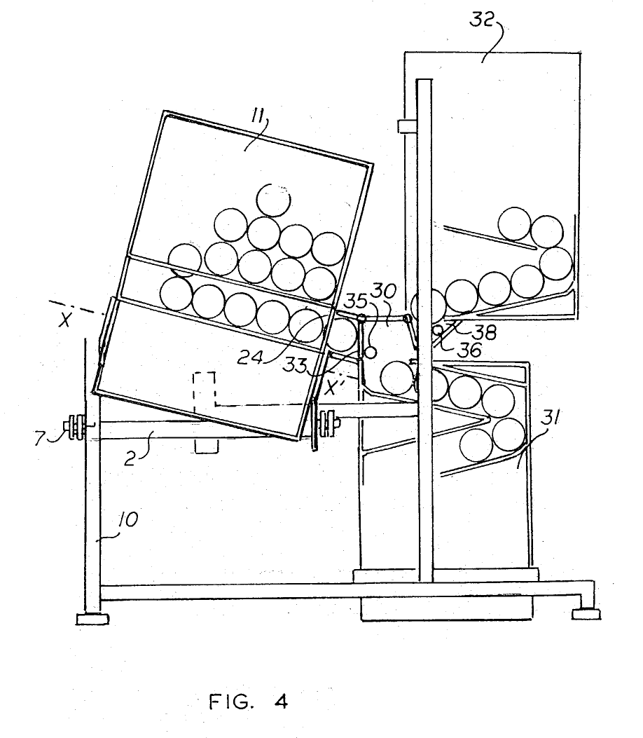

The transfer box 11 more specifically illustrated in FIGS. 2 and 3 has a closed top 17 and four lateral walls 18-21 and an open bottom 13 through which the beverage containers in their flat 4 are introduced. When the loaded transfer box is held in its vertical dispensing position shown in FIG. 4, the columns 22 of containers are held by the grasping fingers 15 above a bottom exit passage 23 leading to an opening 24 at the lowermost forward end of the channel. Below each column of containers, a trap door 25 will keep the column above the passage 23 after the loosening of the fingers until the following column of containers has been released into the passage.

The fingers are grouped into vertical sets interposed between the columns of cans. All fingers in each set are joined by a plate 26 riding on the outer surface of the transfer box top 17. The part 27 of each finger that passes through the top 17 are slightly smaller than the pass-through hole 28 in the top, allowing for a slight lateral play of each set of fingers away from the column of cans immediately preceding that set.

When the transfer box is tilted to its vertical dispensing position all the trap doors 25 are locked in a closed position by cams associated with their respective finger plates. As the carton 4 is removed with the return of the tray to its horizontal position, the last column 29 of cans rolls down into the exit passage 23. The set of fingers immediately preceding the evacuated column of cans are free to move back releasing their grip upon the next column of cans and unlatching the trap door associated with that column. The second column of cans begin rolling into the exit passage behind the last column. The process continue until all the cans have dropped into the passage and been dispensed through the opening 24. It should be noted that the presence of cans rolling through the exit passage prevent the trap door of the not-yet freed column from opening assuring an orderly dispensing of the cans column-by-column begining with the last and highest positioned column.

It should be understood that the trap door could also be sequentially released by any other manual or automatic mechanism, and the transfer box, tray and carton returned to their horizontal position after the transfer box has been emptied.

As more specifically illustrated in FIG. 4, the dispensing opening 24 feeds into a chamber or station 30. The chamber leads to channel toward a vending machine magazine 31 of the type disclosed in the above-referenced U.S. Patent.

The chamber 30 also admits cans arriving through a chute 38 from an alternate package such as a partially expended magazine 32 returned from a vending site. Gates 33, 34 at the two inlets of the chamber allow selection of cans from the transfer box or the expended magazine. Sensors 35, 36 in the forms of contact switches are used to count the number of cans drawn from either source.

When the entire transfer box has been emptied, it is returned to its horizontal loading position above the next carton of cans.

While the preferred embodiment of the invention has been described, modifications can be made and other embodiments may be devised without departing from the spirit of the invention and the scope of the appended claims.

What is claimed is:

1. An apparatus for automatically loading cylindrical containers into a dispensing vessel from a plurality of packages, said apparatus comprising:
means for lifting a layer of said containers held in an axially vetical position in a first package into a transfer box;
means for rotating said transfer box about 90° into a dispensing position to place said containers in an axially horizontal position;
means for sequentially releasing said containers one-by-one out of said transfer box into a channel leading to said vessel.

2. The apparatus of claim 1, which further comprises means for admitting into said channel, containers from an alternate package.

3. The apparatus of claim 1, wherein said transfer box comprises a rectangular case having an open bottom; and
an array of releasable prongs shaped, positioned and dimensioned to grasp said containers.

4. The apparatus of claim 3, wherein said transfer box has an exit passage running on a substantially horizontal direction below said array of prongs when said box is in said dispensing position; and
said box further comprises means for sequentially allowing columns of said container to roll into said passage.

5. The apparatus of claim 4, wherein said means for rotating comprises means for tilting said transfer box to urge rolling movement of said containers within said passage toward an opening in a wall of said box.

6. The apparatus of claim 5 which further comprises means for admitting into said channel containers from an alternate package.

7. The apparatus of claim 6, wherein said means for admitting comprises:
a first gate between said transfer box and said channel;
a chute shaped and dimensioned to lead containers rolling out of said alternate package into said channel; and
a second gate within said chute.

8. The apparatus of claim 2, wherein said first package comprises a carton of beverage cans; and
said vessels comprises an automatic machine magazine.

9. The apparatus of claim 1, wherein said alternate package comprises a partially expended automatic vending machine magazine.
